(19) United States
(12) Patent Application Publication
(10) Pub. No.: US 2024/0051625 A1
(43) Pub. Date: Feb. 15, 2024

(54) RECTIFYING MECHANISM

(71) Applicant: KABUSHIKI KAISHA TOKAI-RIKA-DENKI-SEISAKUSHO, Niwa-gun (JP)

(72) Inventors: Daisuke NAKAYAMA, Aichi (JP); Nobuhiro KUDO, Aichi (JP); Takehiro HAMADA, Aichi (JP); Kazuyuki YOKOYAMA, Aichi (JP)

(21) Appl. No.: 18/446,135

(22) Filed: Aug. 8, 2023

(30) Foreign Application Priority Data
Aug. 12, 2022 (JP) 2022-129091

(51) Int. Cl. B62D 37/02; B62D 35/02

(52) U.S. Cl. CPC B62D 37/02; B62D 35/02

(57) ABSTRACT

In a rectifying mechanism, a left actuator and a right actuator are independently controlled based on a pressure of traveling wind to a vehicle, and a rotation amount of a left deflector and a rotation amount of a right deflector are independently adjusted. Therefore, positions of the deflectors can be appropriately adjusted according to a situation of the vehicle.

### CROSS-REFERENCE TO RELATED APPLICATION

This application is based on and claims priority under 35 USC 119 from Japanese Patent Application No. 2022-129091 filed on Aug. 12, 2022, the disclosure of which is incorporated by reference herein.

### BACKGROUND

### Technical Field

The present invention relates to a rectifying mechanism that suppresses an air flow to a front wheel of a vehicle.

### Related Art

In a movable spoiler device described in JP 2018-70105 A, a spoiler is movable in a vertical direction, and the spoiler is moved from a storage position to a deployment position and deployed to a front side of a front wheel of a vehicle.

By the way, in such a movable spoiler device, it is preferable that the position of the spoiler can be appropriately adjusted according to a situation of the vehicle.

### SUMMARY

In view of the above fact, an object of the present invention is to obtain a rectifying mechanism capable of appropriately adjusting a position of a rectifying body according to a situation of a vehicle.

A rectifying mechanism of a first aspect of the present invention includes: a pair of rectifying bodies that are each moved in a deployment direction to be deployed on a front side of a front wheel of a vehicle, to suppress an air flow to the front wheel, and that are each moved in a housing direction to be housed in a vehicle body; a pressure detection mechanism that detects a pressure of an air flow to the vehicle; and a pair of adjustment mechanisms that adjust respective movement positions of the pair of rectifying bodies, based on the pressure of the air flow to the vehicle detected by the pressure detection mechanism.

In the rectifying mechanism of the first aspect of the present invention, the pair of rectifying bodies are each moved in the deployment direction to be deployed on the front side of the front wheel of the vehicle, to suppress the air flow to the front wheel. Moreover, the pair of rectifying bodies are each moved in the housing direction to be housed in the vehicle body. Furthermore, the pressure detection mechanism detects the pressure of the air flow to the vehicle.

Here, the pair of adjustment mechanisms adjust respective the movement positions of the pair of rectifying bodies, based on the pressure of the air flow to the vehicle detected by the pressure detection mechanism. Therefore, the positions of the rectifying bodies can be appropriately adjusted according to the pressure of the air flow to the vehicle, which is a situation of the vehicle.

A rectifying mechanism according to a second aspect of the present invention is the rectifying mechanism according to the first aspect of the present invention, in which the pressure detection mechanism detects a pressure of an air flow toward the front side of the front wheel.

In the rectifying mechanism of the second aspect of the present invention, the pressure detection mechanism detects the pressure of the air flow toward the front side of the front wheel. Therefore, the position of the rectifying body can be appropriately adjusted according to the pressure of the air flow toward the front side of the front wheel.

A rectifying mechanism of a third aspect of the present invention is the rectifying mechanism of the first aspect or the second aspect of the present invention, in which the pressure detection mechanism is provided at the rectifying body.

In the rectifying mechanism of the third aspect of the present invention, the pressure detection mechanism is provided at the rectifying body. Therefore, the pressure detection mechanism can be easily installed.

A rectifying mechanism according to a fourth aspect of the present invention includes: a pair of rectifying bodies that are each moved in a deployment direction to be deployed on a front side of a front wheel of a vehicle, to suppress an air flow to the front wheel, and that are each moved in a housing direction to be housed in a vehicle body; a steering angle detection mechanism that detects a steering angle of the vehicle; and a pair of adjustment mechanisms that adjust respective movement positions of the pair of rectifying bodies, based on the steering angle of the vehicle detected by the steering angle detection mechanism.

In the rectifying mechanism of the fourth aspect of the present invention, the pair of rectifying bodies are each moved in the deployment direction to be deployed on the front side of the front wheel of the vehicle, to suppress the air flow to the front wheel. Moreover, the pair of rectifying bodies are each moved in the housing direction to be housed in the vehicle body. Furthermore, the steering angle detection mechanism detects the steering angle of the vehicle.

Here, the pair of adjustment mechanisms adjust respective the movement positions of the pair of rectifying bodies, based on the steering angle of the vehicle detected by the steering angle detection mechanism. Therefore, the positions of the rectifying bodies can be appropriately adjusted according to the steering angle of the vehicle, which is a situation of the vehicle.

A rectifying mechanism of a fifth aspect of the present invention includes: a pair of rectifying bodies that are each moved in a deployment direction to be deployed on a front side of a front wheel of a vehicle, to suppress an air flow to the front wheel, and that are each moved in a housing direction to be housed in a vehicle body; an angular velocity detection mechanism that detects an angular velocity of the vehicle; and a pair of adjustment mechanisms that adjust respective movement positions of the pair of rectifying bodies based on the angular velocity of the vehicle detected by the angular velocity detection mechanism.

In the rectifying mechanism of the fifth aspect of the present invention, the pair of rectifying bodies are each moved in the deployment direction to be deployed on the front side of the front wheel of the vehicle, to suppress the air flow to the front wheel. Moreover, the pair of rectifying bodies are each moved in the housing direction to be housed in the vehicle body. Furthermore, the angular velocity detection mechanism detects the angular velocity of the vehicle.

Here, the pair of adjustment mechanisms adjust respective the movement positions of the pair of rectifying bodies, based on the angular velocity of the vehicle detected by the angular velocity detection mechanism. Therefore, the positions of the rectifying bodies can be appropriately adjusted according to the angular velocity of the vehicle, which is a situation of the vehicle.

A rectifying mechanism according to a sixth aspect of the present invention is the rectifying mechanism according to any one of the first to fifth aspects of the present invention, in which the adjustment mechanism adjusts a deployment position of the rectifying body.

In the rectifying mechanism of the sixth aspect of the present invention, the adjusting mechanism adjusts the deployment position of the rectifying body. Therefore, the position of the rectifying body can be more appropriately adjusted.

A rectifying mechanism of a seventh aspect of the present invention includes: a rectifying body that is made rotatable around a front side of a vehicle, that is rotated in a deployment direction to be deployed on a front side of a front wheel of the vehicle, to suppress an air flow to the front wheel, and that is moved in a housing direction to be housed in a vehicle body; a temperature detection mechanism that detects a temperature of a braking mechanism that brakes the front wheel; and an adjustment mechanism that adjusts a deployment position of the rectifying body based on the temperature of the braking mechanism detected by the temperature detection mechanism.

In the rectifying mechanism of the seventh aspect of the present invention, the rectifying body is made rotatable around the front side of the vehicle, and the rectifying body is rotated in the deployment direction to be deployed on the front side of the front wheel of the vehicle, to suppress the air flow to the front wheel. Moreover, the rectifying body is rotated in the housing direction to be housed in the vehicle body. Furthermore, the temperature detection mechanism detects the temperature of the braking mechanism that brakes the front wheel.

Here, the adjustment mechanism adjusts the deployment position of the rectifying body based on the temperature of the braking mechanism detected by the temperature detection mechanism. Therefore, the position of the rectifying body can be appropriately adjusted according to the temperature of the braking mechanism, which is a situation of the vehicle.

A rectifying mechanism according to an eighth aspect of the present invention includes, in the rectifying mechanism according to any one of the first to seventh aspects of the present invention, a rectifying surface that is provided at the rectifying body and that suppresses the air flow to the front wheel by the rectifying body being deployed; and an area adjustment mechanism that adjusts an area of the rectifying surface.

In the rectifying mechanism of the eighth aspect of the present invention, the rectifying body is deployed and the rectifying surface of the rectifying body suppresses the air flow to the front wheel. Here, the area adjustment mechanism adjusts the area of the rectifying surface. Therefore, the air flow to the front wheel can be adjusted.

A rectifying mechanism according to a ninth aspect of the present invention includes, in the rectifying mechanism according to the eighth aspect of the present invention, a rotating part that constitutes the rectifying surface and that is rotated by the area adjustment mechanism to adjust the area of the rectifying surface.

In the rectifying mechanism of the ninth aspect of the present invention, the rotating part constitutes the rectifying surface, and the area adjustment mechanism rotates the rotating part to adjust the area of the rectifying surface. Therefore, the air flow to the front wheels can be adjusted.

A rectifying mechanism according to a tenth aspect of the present invention includes, in the rectifying mechanism according to the eighth or ninth aspect of the present invention, a temperature detection mechanism that detects a temperature of a braking mechanism that brakes the front wheel, wherein the area adjustment mechanism adjusts the area of the rectifying surface based on the temperature of the braking mechanism detected by the temperature detection mechanism.

In the rectifying mechanism of the tenth aspect of the present invention, the temperature detection mechanism detects the temperature of the braking mechanism that brakes the front wheel. Moreover, the area adjustment mechanism adjusts the area of the rectifying surface based on the temperature of the braking mechanism detected by the temperature detection mechanism. Therefore, the air flow to the front wheel can be adjusted based on the temperature of the braking mechanism.

### BRIEF DESCRIPTION OF THE DRAWINGS

Exemplary embodiments of the present invention will be described in detail based on the following figures, wherein:

FIG. 1 is a side view illustrating a front portion of a vehicle to which a rectifying mechanism according to a first embodiment of the present invention is applied as viewed from an outside in a vehicle width direction;

FIG. 2A is a front view of a vehicle to which a rectifying device according to the first embodiment of the present invention is applied when a deflector of the rectifying device is disposed at a maximum deployment position as viewed from a front;

FIG. 2B is a front view of the vehicle to which the rectifying device according to the first embodiment of the present invention is applied when the deflector of the rectifying device is disposed at an intermediate deployment position as viewed from the front;

FIG. 3A is a perspective view of the rectifying device according to the first embodiment of the present invention when the deflector is disposed at a storage position as viewed from the vehicle front side and from the outside in the vehicle width direction;

FIG. 3B is a perspective view of the rectifying device according to the first embodiment of the present invention when the deflector is disposed at the maximum deployment position as viewed from the vehicle front side and from the outside in the vehicle width direction;

FIG. 3C is a perspective view of the rectifying device according to the first embodiment of the present invention when the deflector is disposed at the intermediate deployment position as viewed from the vehicle front side and from the outside in the vehicle width direction;

FIG. 4A is a top view of the deflector of the rectifying device according to the first embodiment of the present invention and a front wheel of the vehicle when the deflector is disposed at the maximum deployment position as viewed from a top;

FIG. 4B is a top view of the deflector of the rectifying device according to the first embodiment of the present invention and the front wheel of the vehicle when the deflector is disposed at the intermediate deployment position as viewed from the top;

FIG. 5A is a perspective view illustrating a closed state of a rotating plate at a deployment position of a deflector in a rectifying device according to a second embodiment of the present invention as viewed from the vehicle front side and from the outside in the vehicle width direction; and

FIG. 5B is a perspective view illustrating a maximum opened state of the rotating plate at the deployment position of the deflector in the rectifying device according to the second embodiment of the present invention as viewed from the vehicle front side and from the outside in the vehicle width direction.

### DETAILED DESCRIPTION

### First Embodiment

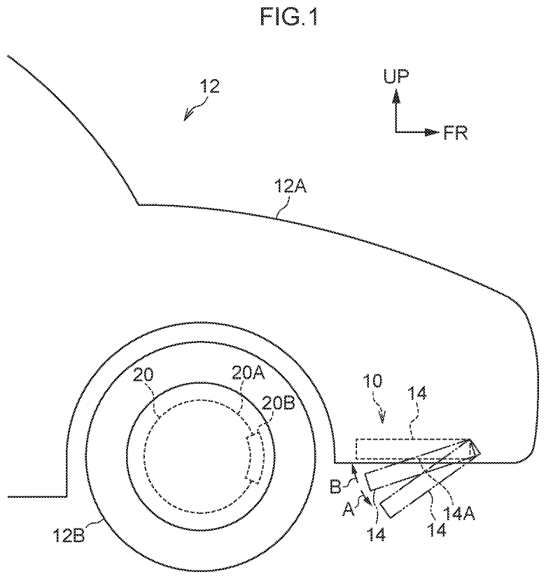

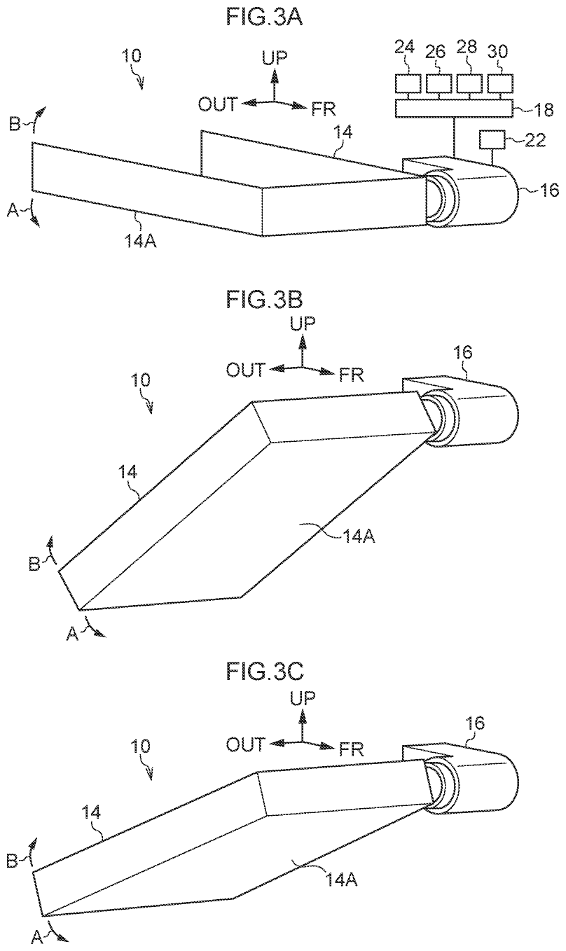

FIG. 1 is a side view of a front portion of a vehicle 12 in to a first embodiment of the present invention as viewed from an outside in a vehicle width direction (a right side of the vehicle), and FIG. 3A is a perspective view of a rectifying device 10 according to the present embodiment as viewed from the vehicle front side and from the outside in the vehicle width direction. Note that, in the drawings, the vehicle front side is indicated by an arrow FR, the outside in the vehicle width direction is indicated by an arrow OUT, and the upper side is indicated by an arrow UP.

As illustrated in FIG. 1, the rectifying device 10 according to the present embodiment is installed on the front side of a front wheel 12B on the left side (vehicle left side) of the vehicle 12 and the front side of the front wheel 12B on the right side (vehicle right side) of the vehicle 12, and is disposed in the front end portion of a vehicle body 12A. The rectifying device 10 on the left side and the rectifying device 10 on the right side constitute a rectifying mechanism, and are configured to be plane-symmetrical with respect to a plane perpendicular to the vehicle width direction at a center in the vehicle width direction of the vehicle 12.

A brake device 20 as a braking mechanism is provided inside each of the front wheels 12B of the vehicle 12 in the vehicle width direction. The brake device 20 is provided with a disk-shaped brake disc 20A, and the brake disc 20A is disposed coaxially with the front wheel 12B and integrally rotated with the front wheel 12B. The brake device 20 is provided with a brake pad 20B, and when the brake device 20 is operated, the brake pad 20B brakes the rotation of the brake disc 20A to brake the front wheel 12B.

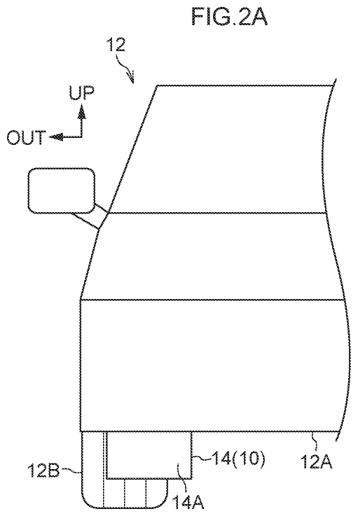

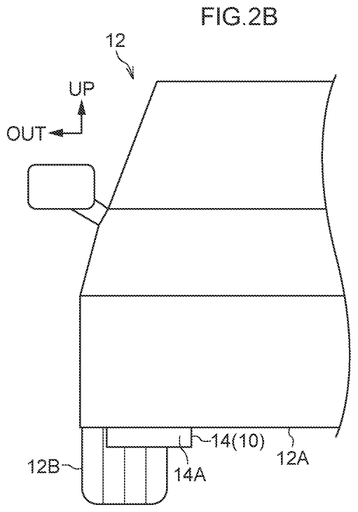

As illustrated in FIGS. 1 and 3A, the rectifying device 10 is provided with a substantially rectangular parallelepiped box-shaped deflector 14 made of resin as a rectifying body, and the deflector 14 is disposed on the vehicle front side of the front wheel 12B and the brake device 20. The inside of the deflector 14 is open to the upper side and the vehicle rear side, and the lower surface of the deflector 14 is a rectifying surface 14A. The deflector 14 is rotatable (movable) about the vehicle front end in a deployment direction A and a housing direction B (see FIG. 1 and the like). The deflector 14 is disposed at a housing position (dashed line position in FIG. 1, position in FIG. 3A), and the deflector 14 is housed in the vehicle body 12A and does not protrude to the lower side of the vehicle body 12A. The deflector 14 is rotated in the deployment direction A to be deployable, whereby the deflector 14 (rectifying surface 14A) protrudes to the lower side of the vehicle body 12A. The deflector 14 can be disposed at a deployment position such as a maximum deployment position (two-dot chain line position in FIG. 1, position in FIGS. 2A and 3B) and an intermediate deployment position (dashed-dotted line position in FIG. 1, position in FIGS. 2B and 3C), and the deflector 14 can be rotated from the deployment position in the housing direction B to be disposed (returned) at the housed position.

An actuator 16 as an adjustment mechanism is mechanically connected to the inside in the vehicle width direction of the vehicle front side end portion of the deflector 14, and the actuator 16 is fixed in the vehicle body 12A to support the deflector 14. The actuator 16 (ECU) is electrically connected to a control device 18 (ECU) of the vehicle 12, and the actuator 16 is operated by the control of the control device 18 to rotate the deflector 14. The actuator 16 is provided with a rotation detection device 22, and the rotation detection device 22 detects the rotation (rotational position or the like) of the deflector 14. The rotation detection device 22 is electrically connected to the control device 18, and the control device 18 operates the actuator 16 based on the rotational position of the deflector 14 detected by the rotation detection device 22.

A temperature detection device 24 as a temperature detection mechanism is electrically connected to the control device 18, and the temperature detection device 24 is provided in each of the brake devices 20 and detects the temperature of each of the brake devices 20 (the temperature of the brake disc 20A or the brake pad 20B). A pair of pressure detection devices 26 as pressure detection mechanisms are electrically connected to the control device 18, and each of the pressure detection devices 26 is provided in the vicinity of the front side of each front wheel 12B of the vehicle 12 (for example, the vehicle rear side end of the rectifying surface 14A of each deflector 14) to detect a pressure (air volume) of traveling wind (air flow) to each front wheel 12B. A steering angle detection device 28 as a steering angle detection mechanism is electrically connected to the control device 18, and the steering angle detection device 28 is provided at a steering (not illustrated) of the vehicle 12 to detect a steering angle (It is an operation angle of the steering, and may be a steering angular velocity of the vehicle 12 (operation angular velocity of the steering) or a steering angular acceleration of the vehicle 12 (operation angular acceleration of the steering)) of the vehicle 12. An angular velocity detection device 30 as an angular velocity detection mechanism is electrically connected to the control device 18, and the angular velocity detection device 30 is provided in the vehicle 12 and detects an angular velocity (It is an angular velocity around the vertical direction, around the front-rear direction, and around the left-right direction of the vehicle 12, and may be an angular acceleration around the vertical direction, around the front-rear direction, and around the left-right direction of the vehicle 12) of the vehicle 12.

Next, the operation of the present embodiment will be described.

In the rectifying device 10 having the above configuration, the deflector 14 is disposed at the housing position and housed in the vehicle body 12A.

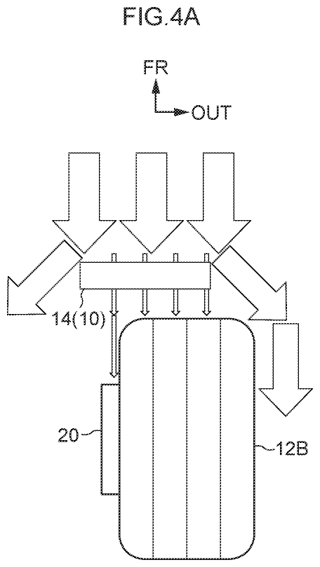

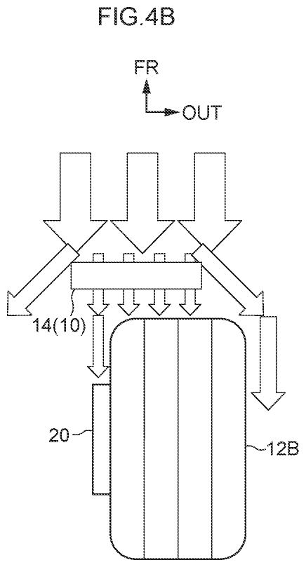

When the vehicle 12 travels at a high speed, the actuator 16 is operated by the control of the control device 18 to rotate the deflector 14 in the deployment direction A, so that the deflector 14 is disposed at the maximum deployment position and protrudes downward from the vehicle body 12A (see FIGS. 2A and 3B). Therefore, the deflector 14 (rectifying surface 14A) is disposed on the vehicle front side of the front wheel 12B below the vehicle body 12A and suppresses the traveling wind of the vehicle 12 toward the front wheel 12B (the traveling wind flows to both outer sides in the vehicle width direction of the front wheel 12B and the brake device 20), so that the increase in the air pressure on the vehicle front side of the front wheel 12B is suppressed and the air resistance and the lift of the vehicle 12 are suppressed (see FIG. 4A).

Thereafter, when the vehicle 12 travels at a low speed, the actuator 16 is operated by the control of the control device 18 to rotate the deflector 14 in the housing direction B, so that the deflector 14 is disposed at the housing position and housed in the vehicle body 12A (see FIG. 3A).

By the way, in a case in which the temperature of the brake device 20 (temperature detected by the temperature detection device 24) is higher than or equal to a predetermined temperature when the deflector 14 is disposed at the maximum deployment position, the actuator 16 is operated by the control of the control device 18 to rotate the deflector 14 in the housing direction B, so that the deflector 14 is disposed at the intermediate deployment position and an amount of protrusion from the vehicle body 12A to the lower side is reduced (see FIGS. 2B and 3C). Therefore, an amount of traveling wind flowing from the deflector 14 (rectifying surface 14A) to the front wheel 12B and the brake device 20 is increased, and the brake device 20 is cooled (see FIG. 4B).

Thereafter, in a case in which the temperature of the brake device 20 (temperature detected by the temperature detection device 24) becomes lower than the predetermined temperature, the actuator 16 is operated by the control of the control device 18 to rotate the deflector 14 in the deployment direction A, whereby the deflector 14 is disposed at the maximum deployment position. Therefore, the air resistance of the vehicle 12 can be appropriately suppressed, and the fuel consumption performance of the vehicle 12 can be improved.

As described above, even when the deflector 14 is disposed at the maximum deployment position, in a case in which the temperature of the brake device 20 is higher than or equal to the predetermined temperature, the deflector 14 is disposed at the intermediate deployment position to increase the amount of the traveling wind flowing to the brake device 20, thereby cooling the brake device 20. Therefore, the fade resistance of the brake device 20 can be improved.

Furthermore, when the vehicle 12 is turned, the control device 18 independently controls the actuator 16 on the left side and the actuator 16 on the right side based on at least one of the steering angle of the vehicle 12 (the steering angle detected by the steering angle detection device 28) or the angular velocity of the vehicle 12 (the angular velocity detected by the angular velocity detection device 30), and a deployed amount of the left deflector 14 (including the housing position) and a deployed amount of the right deflector 14 (including the housing position) are independently adjusted. Therefore, a flow rate of the traveling wind to the left front wheel 12B and a flow rate of the traveling wind to the right front wheel 12B can be independently adjusted, the posture stability of the vehicle 12 can be improved, and the steering responsiveness of the vehicle 12 to the steering operation can be improved.

Moreover, when the vehicle 12 travels straight, for example, in a case in which the vehicle 12 receives a cross wind and a pressure difference occurs between a pressure of the traveling wind toward the left front wheel 12B (a pressure detected by the left pressure detection device 26) and a pressure of the traveling wind toward the right front wheel 12B (a pressure detected by the right pressure detection device 26), the control device 18 independently controls the left actuator 16 and the right actuator 16 on the basis of the pressure difference, and a deployed amount of the left deflector 14 (including the housing position) and a deployed amount of the right deflector 14 (including the housing position) are independently adjusted. Therefore, a flow rate of the traveling wind to the left front wheel 12B and a flow rate of the traveling wind to the right front wheel 12B can be adjusted independently, and the straight traveling stability of the vehicle 12 can be improved.

As described above, the deployment position of the deflector 14 is adjustable. Therefore, the rotational position of the deflector 14 can be appropriately adjusted, and the flow rate of the traveling wind to the front wheel 12B can be appropriately adjusted.

### Second Embodiment

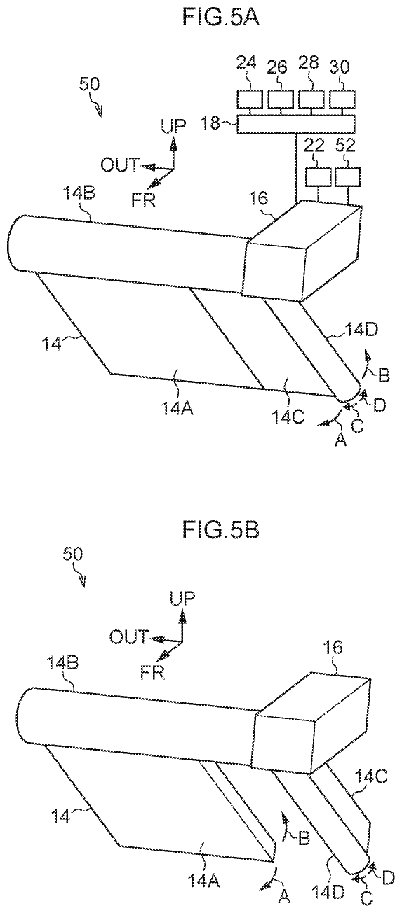

FIG. 5A is a perspective view of a rectifying device 50 according to a second embodiment of the present invention as viewed from the vehicle front side and from the outside in the vehicle width direction.

The rectifying device 50 according to the present embodiment has substantially the same configuration as that of the first embodiment, but differs in the following points.

As illustrated in FIG. 5A, in the rectifying device 50 according to the present embodiment, a deflector 14 has a substantially rectangular plate shape. A columnar first rotation shaft 14B is integrally provided at the vehicle front side of the deflector 14, and the deflector 14 is rotatable about the first rotation shaft 14B in the deployment direction A and the housing direction B.

A rectangular plate-shaped rotating plate 14C as a rotating portion is provided at an inner end in the vehicle width direction of the deflector 14, and the rotating plate 14C is disposed on the vehicle front side of the brake device 20 and is separated from other portions of the deflector 14. On an inner side in the vehicle width direction of the rotating plate 14C, a columnar second rotation shaft 14D is integrally provided, and the second rotation shaft 14D is rotatable in the deployment direction A and the housing direction B integrally with the first rotation shaft 14B. The second rotation shaft 14D is rotatable in an opening direction C and a closing direction D with respect to the first rotation shaft 14B, and the rotating plate 14C is rotatable about the second rotation shaft 14D in the opening direction C and the closing direction D. The rotating plate 14C is disposed in a closed position (a position in FIG. 5A) (closing a rectifying surface 14A (lower surface) of the deflector 14), and the rotating plate 14C is rotated in the opening direction C to reduce an area of the rectifying surface 14A (open the rectifying surface 14A). The rotating plate 14C can be disposed at an open position such as a maximum open position (position of FIG. 5B, position above and perpendicular to a portion of the deflector 14 other than the rotating plate 14C), and the rotating plate 14C is rotated from the open position in the closing direction D to be disposed (returned) at the closed position.

An actuator 16 as an adjustment mechanism and an area adjustment mechanism is mechanically connected to the first rotation shaft 14B of the deflector 14, and the actuator 16 is mechanically connected to the second rotation shaft 14D of the rotating plate 14C. The actuator 16 is operated by the control of the control device 18 to rotate the deflector 14 (including the rotating plate 14C) in the deployment direction A and the housing direction B, and is operated by the control of the control device 18 to rotate the rotating plate 14C in the opening direction C and the closing direction D. The actuator 16 is provided with an opening and closing detection device 52 (area detection device), and the opening and closing detection device 52 detects the rotation (rotational position or the like) of the rotating plate 14C. The opening and closing detection device 52 is electrically connected to the control device 18, and the control device 18 operates the actuator 16 based on the rotational position of the rotating plate 14C detected by the opening and closing detection device 52.

Here, also in the present embodiment, the same functions and effects as those of the first embodiment can be obtained.

Moreover, in a case in which the temperature of the brake device 20 (temperature detected by the temperature detection device 24) is higher than or equal to a predetermined temperature when the deflector 14 is disposed at the deployment position, the actuator 16 is operated by the control of the control device 18 to rotate the rotating plate 14C of the deflector 14 in the opening direction C, so that the deflector 14 is disposed at the maximum open position and an area of the rectifying surface 14A of the deflector 14 is reduced (see FIG. 5B). Therefore, an amount of traveling wind flowing from the deflector 14 (rectifying surface 14A) to the brake device 20 is increased, and the brake device 20 is cooled. Thus, the fade resistance of the brake device 20 can be further improved.

Thereafter, in a case in which the temperature of the brake device 20 (temperature detected by the temperature detection device 24) becomes lower than the predetermined temperature, the actuator 16 is operated by the control of the control device 18 to rotate the rotating plate 14C of the deflector 14 in the closing direction D, so that the rotating plate 14C is disposed at the closed position and the area of the rectifying surface 14A of the deflector 14 is increased. Therefore, the air resistance of the vehicle 12 can be appropriately suppressed, and the fuel consumption performance of the vehicle 12 can be improved.

Furthermore, when the vehicle 12 is turned with the deflector 14 disposed at the deployment position, the control device 18 independently controls the left actuator 16 and the right actuator 16 based on at least one of the steering angle of the vehicle 12 (the steering angle detected by the steering angle detection device 28) or the angular velocity of the vehicle 12 (the angular velocity detected by the angular velocity detection device 30), so that an opening amount (including the closed position) of the left rotating plate 14C and an opening amount (including the closed position) of the right rotating plate 14C are independently adjusted. Therefore, a flow rate of the traveling wind to the left front wheel 12B and a flow rate of the traveling wind to the right front wheel 12B can be adjusted independently, the posture stability of the vehicle 12 can be further improved, and the steering responsiveness of the vehicle 12 to the steering operation can be further improved.

Moreover, when the vehicle 12 travels straight with the deflector 14 disposed at the deployment position, for example, in a case in which the vehicle 12, receives a cross wind and a pressure difference occurs between a pressure of the traveling wind toward the left front wheel 12B (a pressure detected by the left pressure detection device 26) and a pressure of the traveling wind toward the right front wheel 12B (a pressure detected by the right pressure detection device 26), the control device 18 independently controls the left actuator 16 and the right actuator 16 on the basis of the pressure difference, and an opening amount (including the closed position) of the left rotating plate 14C and an opening amount (including the closed position) of the right rotating plate 14C are independently adjusted. Therefore, a flow rate of the traveling wind to the left front wheel 12B and a flow rate of the traveling wind to the right front wheel 12B can be adjusted independently, and the straight traveling stability of the vehicle 12 can be further improved.

In addition, as described above, the opening position of the rotating plate 14C is adjustable. Therefore, the open position of the rotating plate 14C can be appropriately adjusted, and the flow rate of the traveling wind to the front wheel 12B can be appropriately adjusted.

Note that, in the first embodiment and the second embodiment, the rotational position of the left or right deflector 14 (including the rotational position of the rotating plate 14C) is adjusted based on the temperature of the left or right brake device 20. However, the rotational positions of the left and right deflectors 14 (including the rotational position of the rotating plate 14C) may be adjusted based on the temperature of the left or right brake device 20.

Furthermore, in the second embodiment, the deflector 14 is also disposed at a position other than the maximum deployment position as the deployment position. However, the deflector 14 may be disposed only at the maximum deployment position as the deployment position.

What is claimed is:

1. A rectifying mechanism comprising:
a pair of rectifying bodies that are each moved in a deployment direction to be deployed on a front side of a front wheel of a vehicle, to suppress an air flow to the front wheel, and that are each moved in a housing direction to be housed in a vehicle body;
a pressure detection mechanism that detects a pressure of an air flow to the vehicle; and
a pair of adjustment mechanisms that adjust respective movement positions of the pair of rectifying bodies, based on the pressure of the air flow to the vehicle detected by the pressure detection mechanism.

2. The rectifying mechanism according to claim 1, wherein the pressure detection mechanism detects a pressure of an air flow toward the front side of the front wheel.

3. The rectifying mechanism according to claim 1, wherein the pressure detection mechanism is provided at the rectifying body.

4. A rectifying mechanism comprising:
a pair of rectifying bodies that are each moved in a deployment direction to be deployed on a front side of a front wheel of a vehicle, to suppress an air flow to the front wheel, and that are each moved in a housing direction to be housed in a vehicle body;
a steering angle detection mechanism that detects a steering angle of the vehicle; and
a pair of adjustment mechanisms that adjust respective movement positions of the pair of rectifying bodies, based on the steering angle of the vehicle detected by the steering angle detection mechanism.

5. A rectifying mechanism comprising:
a pair of rectifying bodies that are each moved in a deployment direction to be deployed on a front side of a front wheel of a vehicle, to suppress an air flow to the front wheel, and that are each moved in a housing direction to be housed in a vehicle body;
an angular velocity detection mechanism that detects an angular velocity of the vehicle; and
a pair of adjustment mechanisms that adjust respective movement positions of the pair of rectifying bodies, based on the angular velocity of the vehicle detected by the angular velocity detection mechanism.

6. The rectifying mechanism according to claim 1, wherein the adjustment mechanism adjusts a deployment position of the rectifying body.

7. A rectifying mechanism comprising:
a rectifying body that is made rotatable around a front side of a vehicle, that is rotated in a deployment direction to be deployed on a front side of a front wheel of the vehicle, to suppress an air flow, to the front wheel, and that is moved in a housing direction to be housed in a vehicle body;
a temperature detection mechanism that detects a temperature of a braking mechanism that brakes the front wheel; and
an adjustment mechanism that adjusts a deployment position of the rectifying body based on the temperature of the braking mechanism detected by the temperature detection mechanism.

8. The rectifying mechanism according to claim 1, further comprising:
a rectifying surface that is provided at the rectifying body and that suppresses the air flow to the front wheel by the rectifying body being deployed; and
an area adjustment mechanism that adjusts an area of the rectifying surface.

9. The rectifying mechanism according to claim 8, further comprising a rotating part that constitutes the rectifying surface and that is rotated by the area adjustment mechanism to adjust the area of the rectifying surface.

10. The rectifying mechanism according to claim 8, further comprising a temperature detection mechanism that detects a temperature of a braking mechanism that brakes the front wheel,
wherein the area adjustment mechanism adjusts the area of the rectifying surface based on the temperature of the braking mechanism detected by the temperature detection mechanism.

11. The rectifying mechanism according to claim 4, wherein the adjustment mechanism adjusts a deployment position of the rectifying body.

12. The rectifying mechanism according to claim 5, wherein the adjustment mechanism adjusts a deployment position of the rectifying body.

13. The rectifying mechanism according to claim 4, further comprising:
a rectifying surface that is provided at the rectifying body and that suppresses the air flow to the front wheel by the rectifying body being deployed; and
an area adjustment mechanism that adjusts an area of the rectifying surface.

14. The rectifying mechanism according to claim 5, further comprising:
a rectifying surface that is provided at the rectifying body and that suppresses the air flow to the front wheel by the rectifying body being deployed; and
an area adjustment mechanism that adjusts an area of the rectifying surface.

15. The rectifying mechanism according to claim 7, further comprising:
a rectifying surface that is provided at the rectifying body and that suppresses the air flow to the front wheel by the rectifying body being deployed; and
an area adjustment mechanism that adjusts an area of the rectifying surface.

16. The rectifying mechanism according to claim 13, further comprising a rotating part that constitutes the rectifying surface and that is rotated by the area adjustment mechanism to adjust the area of the rectifying surface.

17. The rectifying mechanism according to claim 14, further comprising a rotating part that constitutes the rectifying surface and that is rotated by the area adjustment mechanism to adjust the area of the rectifying surface.

18. The rectifying mechanism according to claim 15, further comprising a rotating part that constitutes the rectifying surface and that is rotated by the area adjustment mechanism to adjust the area of the rectifying surface.
